(19) United States
(12) Patent Application Publication
(10) Pub. No.: US 2019/0283897 A1
(43) Pub. Date: Sep. 19, 2019

(54) COOLED AIR SOURCE FOR A CATALYTIC INERTING CONDENSER

(71) Applicant: Hamilton Sundstrand Corporation, Charlotte, NC (US)

(72) Inventors: Paul M. D'Orlando, Simsbury, CT (US); Eric Surawski, Glastonbury, CT (US)

(21) Appl. No.: 15/924,509

(22) Filed: Mar. 19, 2018

(51) Int. Cl. B64D 37/32; B64D 13/06; B01D 53/26

(52) U.S. Cl. CPC B64D 37/32; B64D 2013/0648; B01D 53/265; B64D 13/06

(57) ABSTRACT

An aircraft inert gas generating system includes a fuel source, an air-fuel mixing unit configured to receive an amount of the fuel and an amount of air an create an air-fuel mixture, and a catalytic oxidation unit downstream of the air-fuel mixing unit and configured to receive and react the air-fuel mixture. The system further includes a condenser downstream of and in flow communication with the catalytic oxidation unit and a cabin exhaust circuit in flow communication with the condenser and configured to provide cabin exhaust air at a first temperature to the condenser. In an alternative embodiment, a pressurized air circuit can provide a stream of cooling air to the condenser. The pressurized air circuit includes a source of pressurized air and a chiller downstream of the source and configured to bring the pressurized air to a first temperature.

### BACKGROUND

Fuel tanks can contain potentially combustible combinations of oxygen, fuel vapors, and ignition sources. To prevent combustion in aircraft fuel tanks, commercial aviation regulations require actively managing the risk of explosion in fuel tank ullages. One type of inerting system uses a catalytic reactor to produce inert gas from hydrocarbon-air mixtures, and these systems often utilize a condenser to remove water from the inert gas before providing the gas to the fuel tank ullage. The condenser operates by cooling water vapor to form liquid water, which is drained from the condenser. The condenser requires a cooling air supply for this purpose. One source of condenser cooling air for current inerting systems includes air that is thermally regulated with a dedicated heat exchanger located in the ram air circuit. This location may, however, experience subfreezing temperatures and cause the liquid water within the condenser to freeze, thus disrupting the production of inert gas. Further, installation of additional componentry within the ram circuit can be challenging, and the heat exchanger may adversely affect performance of the environmental control system.

Reduced bleed environmental controls systems (or eco-ECS) rely on less engine bleed air to operate by supplementing with compressed air from other sources. Such systems, therefore, include additional airflow circuits, which can be tapped to provide air at a suitable temperature to the condenser, thus obviating the need for a dedicated ram air heat exchanger.

### SUMMARY

An aircraft inert gas generating system includes a fuel source, an air-fuel mixing unit configured to receive an amount of the fuel and an amount of air an create an air-fuel mixture, and a catalytic oxidation unit downstream of the air-fuel mixing unit and configured to receive and react the air-fuel mixture. The system further includes a condenser downstream of and in flow communication with the catalytic oxidation unit and a cabin exhaust circuit in flow communication with the condenser and configured to provide cabin exhaust air at a first temperature to the condenser.

An aircraft inert gas generating system includes a fuel source, an air-fuel mixing unit configured to receive an amount of the fuel and an amount of air an create an air-fuel mixture, and a catalytic oxidation unit downstream of the air-fuel mixing unit and configured to receive and react the air-fuel mixture. The system further includes a condenser downstream of and in flow communication with the catalytic oxidation unit, and a pressurized air circuit in flow communication with the condenser and configured to provide a stream of cooling air to the condenser. The pressurized air circuit includes a source of pressurized air and a chiller downstream of the source and configured to bring the pressurized air to a first temperature.

A method of generating inert gas for use in an aircraft includes supplying an amount of fuel to an air-fuel mixing unit, generating an air-fuel mixture within the mixing unit, and providing the mixture to a catalytic oxidation unit. The method further includes reacting the mixture in the catalytic oxidation unit to produce a gaseous mixture, providing the gaseous mixture to a condenser, supplying a stream of cooling air to the condenser, and reducing a temperature of the gaseous mixture using the condenser.

### BRIEF DESCRIPTION OF THE DRAWINGS

FIG. 1 is a schematic illustration of an inerting system.

FIG. 2 is a schematic illustration of a cooling air source for a condenser of the inerting system.

FIG. 3 is a schematic illustration of an alternative cooling air source for the condenser of the inerting system.

### DETAILED DESCRIPTION

The present invention is directed to a catalytic inerting system for an aircraft, and more specifically, to a cooling air source for a condenser of the catalytic inerting system. The cooling air is extracted from an air flow circuit belonging to an eco-ECS system. The cooling air is extracted from a circuit location such that the cooling air falls within a temperature range that is cold enough to facilitate the condensation of water vapor within the catalytic inerting system, but not so cold as to freeze the water.

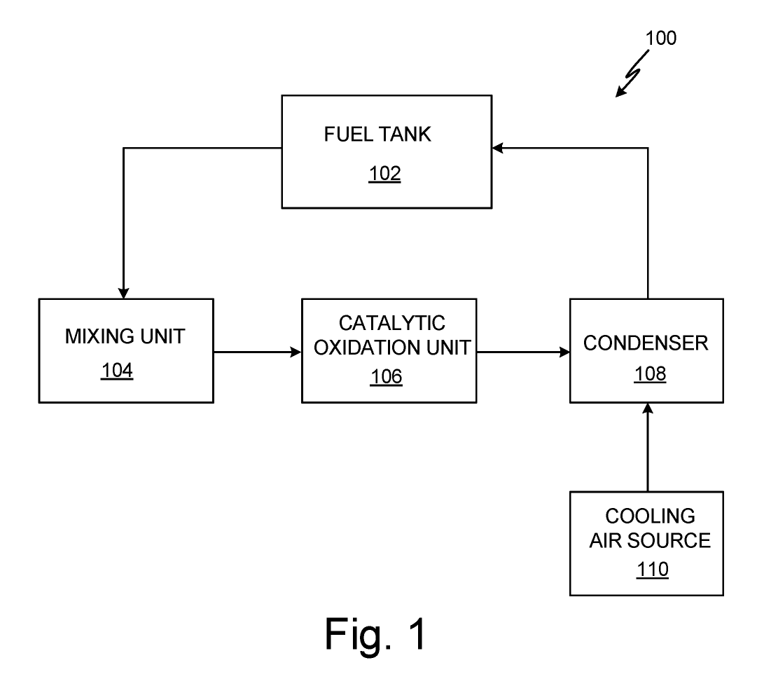

FIG. 1 is a schematic illustration of inerting system 100. Inerting system 100 includes fuel tank 102, mixing unit 104, catalytic oxidation unit 106, and condenser 108, which receives air from cooling air source 110. Fuel tank 102 is fluidly connected to mixing unit 104 such that an amount of hydrocarbon fuel from fuel tank 102 can be provided to mixing unit 104 and combined with an amount of oxygen rich air from an air source (not shown). Mixing unit 104 and catalytic oxidation unit 106 are fluidly connected such that the air-fuel mixture from mixing unit 104 can be provided to catalytic oxidation unit 106 and reacted with a catalyst to form a hot, gaseous reaction mixture containing, for example, nitrogen, carbon dioxide, and water vapor. Condenser 108 is fluidly connected to catalytic oxidation unit 106 such that it receives the gaseous reaction mixture and, using cooling air from cooling air source 110, cools the hot mixture, and further condenses and removes the water vapor, leaving behind an inert gas containing primarily carbon dioxide with some nitrogen. Condenser 108 is fluidly connected to fuel tank 102 such that the inert gas is provided to fuel tank 102 for ullage passivation. In other embodiments, the inert gas can additionally or alternatively be provided to another aircraft system requiring inert gas, such as a cargo hold fire suppression system (not shown). Also not shown in FIG. 1 are various other components, such as pumps, valves, and sensors, configured to control the movement of fluid throughout inerting system 100 that can be included in certain embodiments.

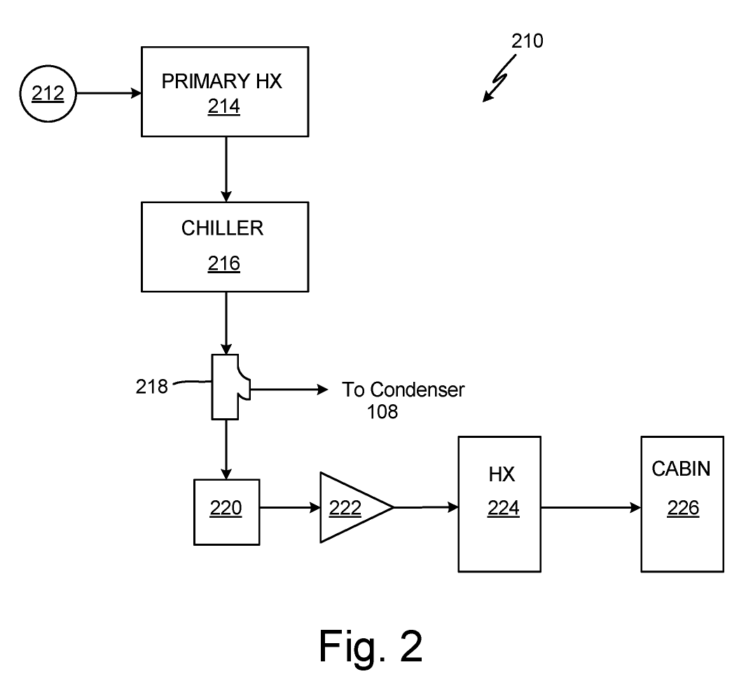

FIG. 2 is a schematic illustration of an embodiment of cooling air source 110 suitable for use with condenser 108. More specifically, cooling air source 210 is an air flow circuit configured to provide thermally regulated air to an aircraft cabin. Cooling air source 210 includes pressurized air source 212, which can be, for example, a source of engine bleed air or compressor air. The pressurized air entering the air flow circuit can have a temperature of roughly 450° F. Cooling air source 210 further includes primary heat exchanger 214, chiller 216, duct 218, water extractor 220, turbine 222, and condensing heat exchanger 224. In operation, pressurized air from source 212 flows first through primary heat exchanger 214, then 216, and exits chiller 216 at a significantly reduced temperature ranging from about 158-212° F. An amount of the cooled pressurized air can then be extracted by duct 218 positioned downstream of chiller 216. As can be seen in FIG. 2, the extracted air can be provided to condenser 108 of inerting system 100, and the stream of cooled air is suitable for removing water from the gaseous reaction mixture. In order to provide the cooled pressurized air to condenser 108, duct 218 is fluidly connected to condenser 108 either directly, or with various intervening components. Although described as a duct in the disclosed embodiment, duct 218 can be any suitable air extraction device such as a tap, port, valve, or flow line.

The remainder of the pressurized air continues through the circuit through water extractor 220 and turbine 222. The pressurized air drives turbine 222 which powers a compressor of an air cycle machine (not shown). The pressurized air then flows through heat exchanger 224, and can then be provided to aircraft cabin 226. In other embodiments, the pressurized air can be provided to any space requiring pressurized and thermally regulated air.

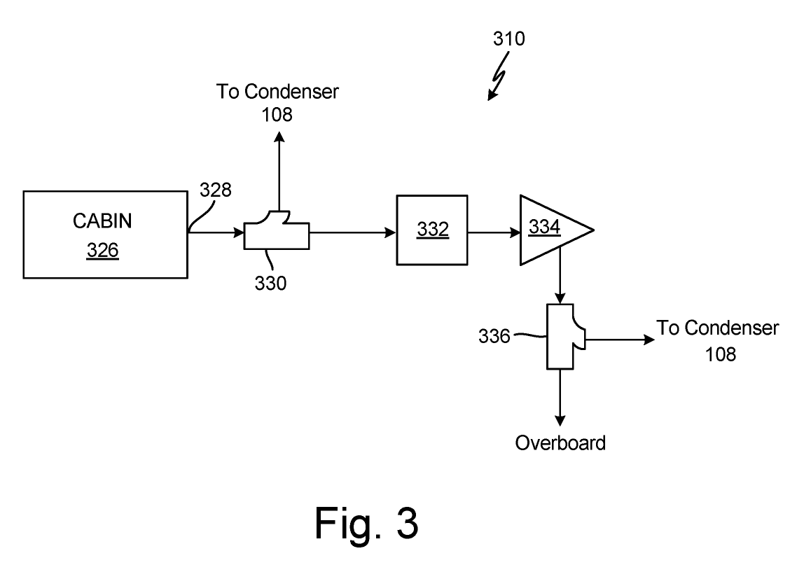

FIG. 3 is a schematic illustration of an alternative embodiment a cooling air source suitable for use with condenser 108. More specifically, cooling air source 310 is a cabin exhaust circuit that utilizes air that would otherwise be dumped overboard to power an air cycle machine. Cooling air source includes cabin 326 with outlet 328, first duct 330, heat exchanger 332, turbine 334, and second duct 336, which can be used as an alternative to first duct 330 in some embodiments. In operation, air is continually displaced from cabin 326 as “new” air (a combination of recycled cabin air and ECS air) flows in. The displaced air is exhausted from cabin 326 from outlet 328 which can be a vent, valve, or other suitable outlet. The exhaust air can have a temperature ranging from about 70-100° F. First duct 330 is positioned downstream of outlet 328 and is configured to extract an amount of cabin exhaust air, and further to provide the extracted exhaust air to condenser 108 of inerting system 108.

The remainder of the exhaust air continues to flow through the remainder of the circuit. The air flows through heat exchanger 332, then to turbine 334. The air drives turbine 334 which powers a compressor of an air cycle machine (not shown), and the air is further cooled by turbine 334. In embodiments without the upstream, first duct 330, the air can be extracted by second duct 336 and provided to condenser 108. The remainder of the air is dumped overboard. As was the case with duct 218 of FIG. 2, each of ducts 330 and 336 of the present embodiment can be directly connected, or connected through intervening components to condenser 108. Ducts 330 and 336 can further be one or a combination of taps, ports, valves, or flow lines in other embodiments.

The use of the disclosed cooling air sources in conjunction with a catalytic inerting system has many benefits. Each takes advantage of available cool air within existing eco-ECS air flow circuits, so no dedicated ram circuit heat exchanger is required. Further, the cooling air circuits can be fluidly connected to the catalytic inerting system with minimal additional componentry.

Those of skill in the art will appreciate that other configurations may be used without departing from the scope of the invention. For example, although described independently, cooling air sources 210 and 310 can be used in combination to provide cooling air to condenser 108. Such operation of cooling air sources 210 and 310 depends on, for example, flow volume through the circuits of sources 210 and 310 and inert gas requirement. Further, although there are valves and junctions illustratively shown at certain locations within the system(s), those of skill in the art will appreciate that these locations are merely for example only and other configurations may be used. Moreover, the order of components shown and described herein, in terms of the flow line and direction of air flow through the system may be changed without departing from the scope of the invention. For example, the location of the heat exchangers, turbines, ducts, etc. may be adjusted based on the specific systems and efficiencies therein.

Discussion of Possible Embodiments

The following are non-exclusive descriptions of possible embodiments of the present invention.

An aircraft inert gas generating system includes a fuel source, an air-fuel mixing unit configured to receive an amount of the fuel and an amount of air an create an air-fuel mixture, and a catalytic oxidation unit downstream of the air-fuel mixing unit and configured to receive and react the air-fuel mixture. The system further includes a condenser downstream of and in flow communication with the catalytic oxidation unit and a cabin exhaust circuit in flow communication with the condenser and configured to provide cabin exhaust air at a first temperature to the condenser.

The system of the preceding paragraph can optionally include, additionally and/or alternatively, any one or more of the following features, configurations and/or additional components:

In the above system, the first temperature can be below 100° F. (38° C.).

In any of the above systems, the first temperature can be below 80° F. (27° C.).

Any of the above systems can further include a duct configured to supply an amount of the cabin exhaust air to the condenser.

Any of the above systems can further include a turbine configured to power an air cycle machine compressor in response to a flow of the cabin exhaust air.

In any of the above systems, the duct can be positioned to extract cabin exhaust air at a location upstream of the turbine.

In any of the above systems, the duct can be positioned to extract cabin exhaust air at a location downstream of the turbine.

An aircraft inert gas generating system includes a fuel source, an air-fuel mixing unit configured to receive an amount of the fuel and an amount of air an create an air-fuel mixture, and a catalytic oxidation unit downstream of the air-fuel mixing unit and configured to receive and react the air-fuel mixture. The system further includes a condenser downstream of and in flow communication with the catalytic oxidation unit, and a pressurized air circuit in flow communication with the condenser and configured to provide a stream of cooling air to the condenser. The pressurized air circuit includes a source of pressurized air and a chiller downstream of the source and configured to bring the pressurized air to a first temperature.

The system of the preceding paragraph can optionally include, additionally and/or alternatively, any one or more of the following features, configurations and/or additional components:

In the above system, the catalytic oxidation unit can generate a gaseous mixture.

In any of the above systems, the condenser can reduce a temperature of the gaseous mixture to remove liquid water from the gaseous mixture.

In any of the above systems, the first temperature can be below 212° F. (100° C.).

In any of the above systems, the first temperature can be below 160° F. (71° C.).

Any of the above systems can further include a primary heat exchanger upstream of the chiller.

Any of the above systems can further include a duct downstream of the chiller and configured to supply an amount of the pressurized air at the first temperature to the condenser.

Any of the above systems can further include a turbine downstream of the chiller and configured to power an air cycle machine compressor in response to a flow of the pressurized air.

A method of generating inert gas for use in an aircraft includes supplying an amount of fuel to an air-fuel mixing unit, generating an air-fuel mixture within the mixing unit, and providing the mixture to a catalytic oxidation unit. The method further includes reacting the mixture in the catalytic oxidation unit to produce a gaseous mixture, providing the gaseous mixture to a condenser, supplying a stream of cooling air to the condenser, and reducing a temperature of the gaseous mixture using the condenser.

The method of the preceding paragraph can optionally include, additionally and/or alternatively, any one or more of the following features, configurations and/or additional components:

In the above method, the stream of cooling air can be supplied from a fluid circuit within an unpressurized space within the aircraft.

In any of the above methods, a duct can connect the fluid circuit with the condenser.

In any of the above methods, the fluid circuit can be a pressurized air circuit that includes a source of pressurized air and a chiller downstream of and in flow communication with the source.

In any of the above methods, the air source can be a cabin exhaust circuit comprising a source of cabin exhaust air.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. An aircraft inert gas generating system comprising:
a fuel source;
an air-fuel mixing unit configured to receive an amount of the fuel and an amount of air and create an air-fuel mixture;
a catalytic oxidation unit downstream of the air-fuel mixing unit and configured to receive and react the air-fuel mixture;
a condenser downstream of and in flow communication with the catalytic oxidation unit; and
a cabin exhaust circuit in flow communication with the condenser and configured to provide cabin exhaust air at a first temperature to the condenser.

2. The system of claim 1, wherein the first temperature is below 100° F. (38° C.).

3. The system of claim 2, wherein the first temperature is below 80° F. (27° C.).

4. The system of claim 1 and further comprising: a duct configured to supply an amount of the cabin exhaust air to the condenser.

5. The system of claim 4 and further comprising: a turbine configured to power an air cycle machine compressor in response to a flow of the cabin exhaust air.

6. The system of claim 5, wherein the duct is positioned to extract cabin exhaust air at a location upstream of the turbine.

7. The system of claim 5, wherein the duct is positioned to extract cabin exhaust air at a location downstream of the turbine.

8. An aircraft inert gas generating system comprising:
a fuel source;
an air-fuel mixing unit configured to receive an amount of the fuel and an amount of air and create an air-fuel mixture;
a catalytic oxidation unit downstream of the air-fuel mixing unit and configured to receive and react the air-fuel mixture;
a condenser downstream of and in flow communication with the catalytic oxidation unit; and
a pressurized air circuit in flow communication with the condenser and configured to provide a stream of cooling air to the condenser, wherein the pressurized air circuit comprises:
a source of pressurized air; and
a chiller downstream of the source and configured to bring the pressurized air to a first temperature.

9. The system of claim 8, wherein the catalytic oxidation unit generates a gaseous mixture.

10. The system of claim 9, wherein the condenser reduces a temperature of the gaseous mixture to remove liquid water from the gaseous mixture.

11. The system of claim 8, wherein the first temperature is below 212° F. (100° C.).

12. The system of claim 11, wherein the first temperature is below 160° F. (71° C.).

13. The system of claim 8 and further comprising: a primary heat exchanger upstream of the chiller.

14. The system of claim 8 and further comprising: a duct downstream of the chiller and configured to supply an amount of the pressurized air at the first temperature to the condenser.

15. The system of claim 8 and further comprising: a turbine downstream of the chiller and configured to power an air cycle machine compressor in response to a flow of the pressurized air.

16. A method of generating inert gas for use in an aircraft, the method comprising:
supplying an amount of fuel to an air-fuel mixing unit;
generating an air-fuel mixture within the mixing unit;
providing the mixture to a catalytic oxidation unit;
reacting the mixture in the catalytic oxidation unit to produce a gaseous mixture;
providing the gaseous mixture to a condenser supplying a stream of cooling air to the condenser; and
reducing a temperature of the gaseous mixture using the condenser.

17. The method of claim 16, wherein the stream of cooling air is supplied from a fluid circuit within an unpressurized space within the aircraft.

18. The method of claim 17, wherein a duct connects the fluid circuit with the condenser.

19. The method of claim 17, wherein the fluid circuit is a pressurized air circuit comprising:
a source of pressurized air; and
a chiller downstream of and in flow communication with the source.

20. The method of claim 17, wherein the air source is a cabin exhaust circuit comprising a source of cabin exhaust air.
